(19) United States
(12) Patent Application Publication
(10) Pub. No.: US 2005/0135313 A1
(43) Pub. Date: Jun. 23, 2005

(54) Method for determining when to increase capacity in a wireless communications system

(76) Inventors: Asif D. Gandhi, Iselin, NJ (US); Mark E. Newbury, Hillsborough, NJ (US)

Correspondence Address: Lucent Technologies Inc.;Docket Administrator, Room 3J-219, 101 Crawfords Corner Road, Holmdel, NJ, 07733-3030, US

(21) Appl. No.: 10/745,086

(22) Filed: Dec. 23, 2003

(51) Int. Cl. H04B 7/216

(52) U.S. Cl. 370/335

(57) ABSTRACT

In a CDMA wireless communications system, the time at which a particular cell sector will reach its maximum capacity is predicted by extrapolating from current service measurements in that sector and using a service provider's projections of traffic growth in order to estimate the point in time at which the traffic level in that sector will cause the total power usage at the base station in that sector to reach a level at which a particular overload condition will exist, where that particular overload condition is manifested in a predetermined blocking criteria. Conventional service measurement data is used to develop an individual characteristic for each sector, which is used to project that sector's maximum capacity. From that maximum capacity, a determination of when that capacity is likely to be reached is then made from projected traffic growth patterns for that sector.

### TECHNICAL FIELD

This invention relates to wireless communications, and more particularly, to base stations within a CDMA wireless communications system.

### BACKGROUND OF THE INVENTION

The maximum capacity of a cell site is a critical parameter in network planning. As the live traffic at a cell site reaches its maximum capacity, in order to avoid a high level of blocking, a service provider needs to add more capacity by purchasing additional equipment and implementing new carriers. The service provider can reactively respond to capacity overloads (i.e., an observed high level of blocking) and use these as the trigger to make arrangements to increase the capacity of its equipment within a cell. Disadvantageously, however, due to the lead time required to increase capacity due to the ordering, local area building approvals, and installation processes, a reactive strategy will likely result in a prolonged period in which the service provider's customers suffer service degradation within the overloaded cell.

A proactive strategy in which the service provider is able to determine when it should make arrangements to add more capacity would be much more advantageous from both the service provider's and its customers' standpoints. Whereas in a conventional technology such as AMPS or TDMA, the maximum capacity of a cell site is known because it is dictated in resource planning (e.g., only a fixed, maximum number of time slots or frequency slots are available), the maximum capacity of a CDMA cell is variable. The capacity of a CDMA cell is dependent on conditions such as typical subscriber speeds, typical subscriber locations, and the conditions in surrounding cells. Accordingly, in a CDMA system, a cell's maximum capacity is not known in advance. Thus, the variable per-cell maximum capacity makes it difficult to predict when in time a particular cell is likely to become overloaded. Thus, an accurate methodology for determining a cell's capacity, and predicting when in time that capacity is likely to be reached on an individual cell-by-cell or cell sector-by-cell sector basis would be extremely beneficial in enabling service providers to proactively plan for future growth.

### SUMMARY OF THE INVENTION

In accordance with an embodiment of the present invention, in a CDMA wireless communications system, the time at which a particular cell sector will reach its maximum capacity is predicted by extrapolating from current service measurements in that sector and using a service provider's projections of traffic growth in order to estimate the point in time at which the traffic level in that sector will cause the total power usage at the base station in that sector to reach a level at which a particular overload condition will exist, where that particular overload condition is manifested in a predetermined blocking criteria. Thus, conventional service measurement data is used to develop an individual characteristic for each sector, which is used to project that sector's maximum capacity. From that maximum capacity, a determination of when that capacity is likely to be reached is then made from projected traffic growth patterns for that sector.

In a first embodiment, in a sector in which only a single type of traffic is present, such as only 2G-voice traffic or only 3G-voice traffic, the specific conventional service measurement is made of traffic, measured in terms of primary Erlangs, as a function of hourly power usage as normalized by the maximum sector power. Using the measured data for lower normalized average power, the level of traffic that can be supported at the power threshold at which undesirable blocking will occur is determined. The inventors of the present invention have determined that a carrier tends to show overload in the range of approximately 0.80 to 0.95 of normalized total power, reaching ˜2% blocking (i.e., the system blocks calls approximately 2% of the time) at that point. Thus, by extrapolating the service measurements at lower normalized average total power to a normalized power threshold within that range, for example to 0.90, the supportable primary Erlangs, and thus capacity of the sector, associated with that power threshold are determined. Using projected traffic growth from current busy-hour traffic, the point in time in the future when that primary Erlang level is likely to be reached can be determined and used as an indicator as to when capacity in that particular sector needs to be increased.

In a second embodiment, a sector is considered that might be supporting a combination of 2G-voice traffic, 3G-voice traffic, and 3G-data traffic. In this second embodiment for mixed traffic types, the relationship between an historical timeline and the normalized total base station power for a sector of interest for the sector's busiest hours is used to project into the future to determine when the normalized total power is likely to reach the level at which an overload condition has been determined to occur, as for example, when the normalized total power reaches 0.90. The time interval between the present and that point in the future when the overload condition is expected to occur will depend on the service provider's predicted growth pattern of traffic. In this second embodiment, a simplified approach is taken in that a uniform growth rate is applied to the total traffic as a whole and not individually to each type of traffic. That overall growth pattern can be consistent with an historical constant growth rate that has been experienced in that sector by the service provider, or can be at either a higher or lower rate depending upon the service provider's intent to offer special promotions or other projected events that could affect the number of customers and thus the traffic within the sector.

In a third embodiment of the present invention, a more general approach is taken in that the effect and predicted growth rate of each type of traffic is considered separately. In this embodiment, using service measurement data, the power usage per unit of traffic for each traffic type in the sector is determined in order to predict the point when the total normalized power reaches the overload threshold level, for example, of 0.90. Using the determined power usage per unit of traffic and the relative composition of each type of traffic in the sector, and the projected growth rate of each type of traffic, a determination is made of when the total normalized power will reach that threshold level in that sector and thus require an additional carrier to satisfy blocking objectives.

### BRIEF DESCSRIPTION OF THE DRAWING

FIG. 1 shows and exemplary service measurement plot of normalized average power versus traffic in a single traffic type sector;

FIG. 2 shows an exemplary service provider's time versus traffic level with a projection into the future for determining when overload will occur for the single traffic type embodiment of the invention;

FIG. 3 shows an exemplary plot of time versus normalized base station power with a projection into the future for the second embodiment of the invention;

FIG. 4 shows, for a third embodiment, exemplary historical and projected traffic usage for each of three types of simultaneous types of traffic of a carrier;

FIG. 5 shows exemplary raw service measurement data of normalized total power versus 2G-only traffic on a carrier. This information is useful in predicting the power requirements of 3G subscribers within a carrier that has mixed 2G and 3G voice traffic;

FIG. 6 shows the exemplary data of FIG. 5 as re-formatted into bins of predetermined width;

FIGS. 7 and 8 show exemplary normalized total power versus binned mixed 2G and 3G traffic levels as measured over two different time intervals; and

FIG. 9 shows an exemplary relationship between total normalized power and power per unit of traffic for 2G and 3G voice traffic in a mixed carrier, and as extrapolated to the threshold level.

### DETAILED DESCRIPTION

In a wireless communications system, each sector of a base station has a fixed amount of downlink (forward link) power available to support traffic. When that power is exhausted, an overload is declared. At overload, the sector will accept no further traffic and blocking occurs. Thus, at overload, the sector will refuse additional users because it requires all of its available power to support current users.

In most situations a one to two percent blocking (i.e., for a total of 36 seconds or 72 seconds, respectively, out of each hour, new calls will be blocked) is generally considered to be acceptable. Thus, if blocking occurs on average only between 36 to 72 seconds in each hour, performance is tolerable. The inventors herein have determined that a carrier within a sector will reach overload when the total power usage within the sector is in the range of 0.80 to 0.95 of normalized power usage. Specifically, this value is independent of the combination of 2G voice users, 3G voice users, and 3G data users in the sector. For any mix of users, the carrier is likely to reach ˜2% blocking at this point, thereby requiring the service provider to increase its capacity (i.e., to provide an additional carrier to handle the increased traffic).

Although a sector will experience blocking when total power usage reaches ˜90% of available power, the capacity (e.g., Erlangs) associated with this value is not known with accuracy. For example, one sector may be capable of developing 22 Erlangs of traffic at 90% power, whereas another sector may develop 30 Erlangs at the same 90% power. The particular capacity value at which a particular sector will block is a key parameter and is of great use in planning for capacity expansion if that capacity value and when that capacity value is likely to be reached can be predicted in advance.

In a first embodiment of the present invention, an algorithm is provided for determining when to increase capacity in a sector in which only a single type of traffic is supported, such as 2G or 3G voice services. With reference to FIG. 1, an exemplary service measurement plot is shown of normalized average power versus primary Erlang usage of a 2G-only sector-carrier (determined using hourly data) on a sector carrier. The plot of representative data shows that as the Erlang usage on a sector-carrier increases, that sector-carrier's power consumption also increases. Further, the trend is approximately linear, to which a best-fit line can be determined. The solid line 101 represents the best-fit line to the representative and illustrative data. By linearly extrapolating the solid line 101 (dashed line 102), to the power threshold, P₁, which is determined to be the level at which an undesirable degree of blocking on a carrier will occur and for this example is 0.90, the supportable primary Erlangs, Eₜ₁, in this sector that corresponds to that threshold can be determined.

By using higher order (i.e., nonlinear) curves to fit the existing data, the accuracy of predicting the maximum capacity of the sector-carrier increases. Further, as more data points at higher power usage levels are collected as the sector traffic grows, the best-fit line or non-linear curve will enable a more accurate prediction of the maximum traffic capacity associated with that power level to be determined. This methodology of extrapolating to the maximum Erlang capacity is applied to any sector of the cell site. For each such sector, the resultant maximum supported Erlangs on a carrier at the predetermined power threshold would be different since each CDMA sector is likely to have a different traffic capacity for the reasons previously discussed.

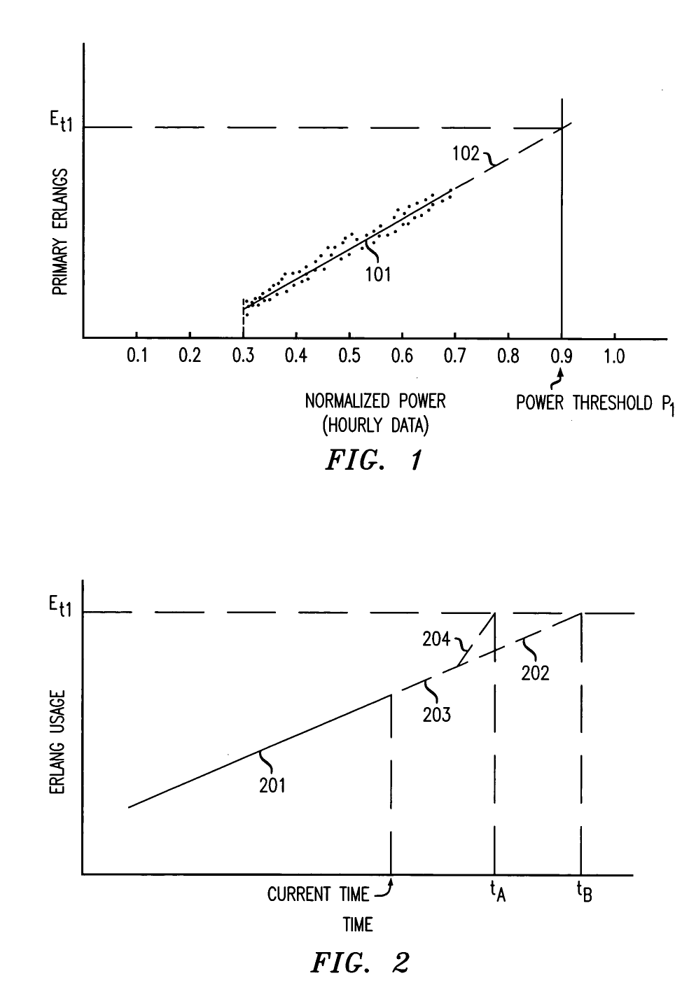

Once this maximum carrier traffic capacity associated with the power threshold for this sector is determined, a prediction of when that level of traffic will be reached can be determined from a service provider's timeline projections of traffic growth. FIG. 2 shows an example of a service provider's historical time versus Erlang usage of a carrier at that sector. As can be noted, the relationship between time and traffic usage is shown as being linear (solid line 201) until the current time. The determination of the point at which maximum Erlang usage of Eₜ₁, of that sector will be reached is a function of the service provider's prediction of growth of that type of traffic within that sector. Thus, for example, if a continued uniform growth pattern is expected to occur, linear line 201 can be extended (dashed line 202) as shown, from which the time t_{B} associated with Eₜ₁ Erlang usage is determined. On the other hand, for example, if the service provider plans on introducing new and more aggressive pricing plans at some point 203 in the future, then growth from that point forward (dotted line 204) can be predicted to increase at a faster rate thereafter. Thus, Erlang usage will reach the threshold of Eₜ₁ at a time t_{A} that is sooner to the present time than time t_{B}. Once a prediction of the point in time at which the maximum capacity will be reached has been made, the capacity within the sector can be increased by adding a new carrier, for example, sufficiently before that maximum capacity is actually reached, but not at too early a time so as to not be cost effective to the service provider to do so.

It should be noted that as more and more on-going service measurement data is collected and a better-fit curve or line determined, the supportable maximum traffic that is associated with the predetermined power threshold P₁ in a particular sector can be recalculated. Then, using additional gathered data that associates historical time versus total Erlang usage, and improved projections of future growth, an improved projection of the time to reach that recalculated level of supportable primary Erlangs can be recalculated.

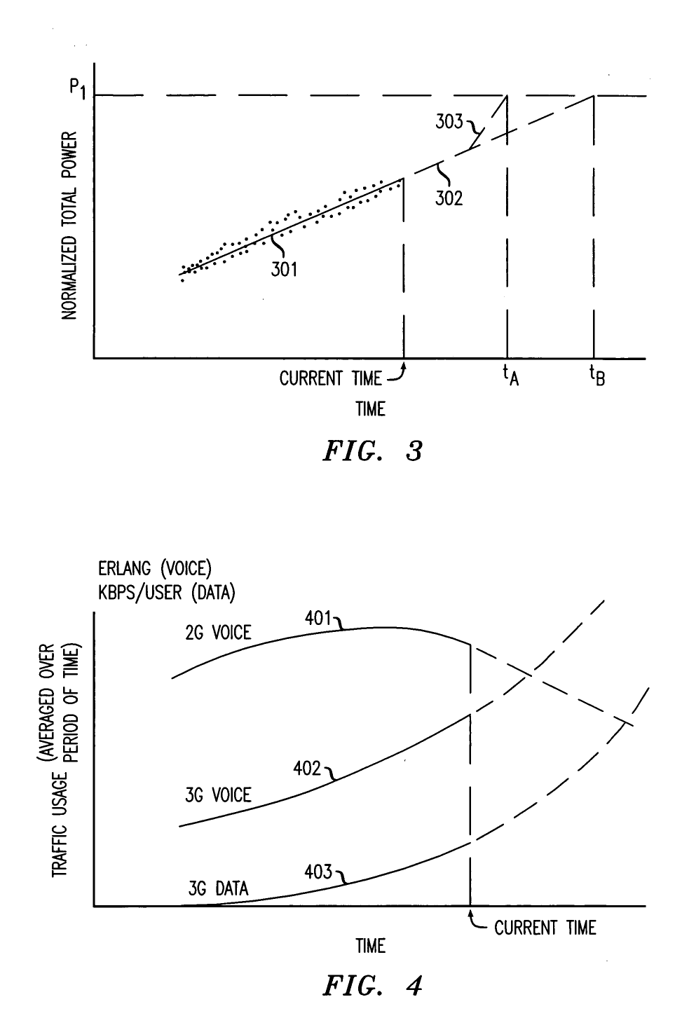

In a second embodiment, a mix of traffic types is present in a sector. It is assumed, however, that they each have similar growth patterns so as to simplify the analysis and projection of when the maximum capacity of that sector will be reached. In this embodiment, the relationship between historical time and total busy hour-average normalized total power usage for the mixed traffic versus is determined. For example, FIG. 3 shows an exemplary plot of time versus the normalized base station sector power determined from service measurements at the busiest base station hour. As more mobile terminal users are added, and voice and data usage increases, the total normalized power is noted to increase in a relatively linear manner, with a best-fit line 301 approximating the relationship. If the growth rate in the future is expected to be consistent the past, then time in the future at which the normalized total power will reach the threshold level, P₁, such as 0.090, that is associated with an undesirable level of blocking can be determined by extending straight line 301 by dotted line 302 until it reaches that threshold. If the growth rate is expected increase at some time in the future, then that expected growth rate (e.g., see dashed line 303) could be used to project when the threshold P₁ will be reached.

In a third embodiment of the present invention, a sector is considered in which different types of traffic are commonly present, such as 2G voice, 3G voice and 3G data, wherein each type of traffic has individual growth rates. In such a sector, for example, one carrier might have mixed 2G and 3G subscribers, and another carrier might only have 2G subscribers. Depending on the type of traffic, a carrier is likely to simultaneously support different numbers of subscribers. For example, if a carrier has only 3G-8 kbps voice subscribers, it on average might be able to support 26 users, whereas a carrier that has only 2G-8 kbps voice users might only support 13 users, and a carrier that has only 2G-13 kbps users might only support 8 users. In this third embodiment, as will be described, the object is to determine how much power per unit of traffic is being used for each type of traffic. Once that information is determined, using the fraction of each type of traffic and separate expected growth rates of each type of traffic, the point in time can be determined when the total power on a carrier can be predicted to reach the afore-described level at which undesirable blocking will occur.

FIG. 4 illustrates an example of usage of different types of traffic in an exemplary sector having 2G voice users, 3G voice users and 3G data users based on historical data and projected growth rates of each type. For the 2G and 3G voice traffic, represented by curves 401 and 402, respectively, usage is in terms of Erlangs, while for 3G data traffic, represented by curve 403, usage is in terms of kbps per user. As can be noted, in this illustrative example, 3G voice and 3G data traffic is shown as expecting to increase in the future with the introduction of new technology, while 2G traffic is shown as expecting to decrease in the future as 2G users replace their terminals with 3G terminals.

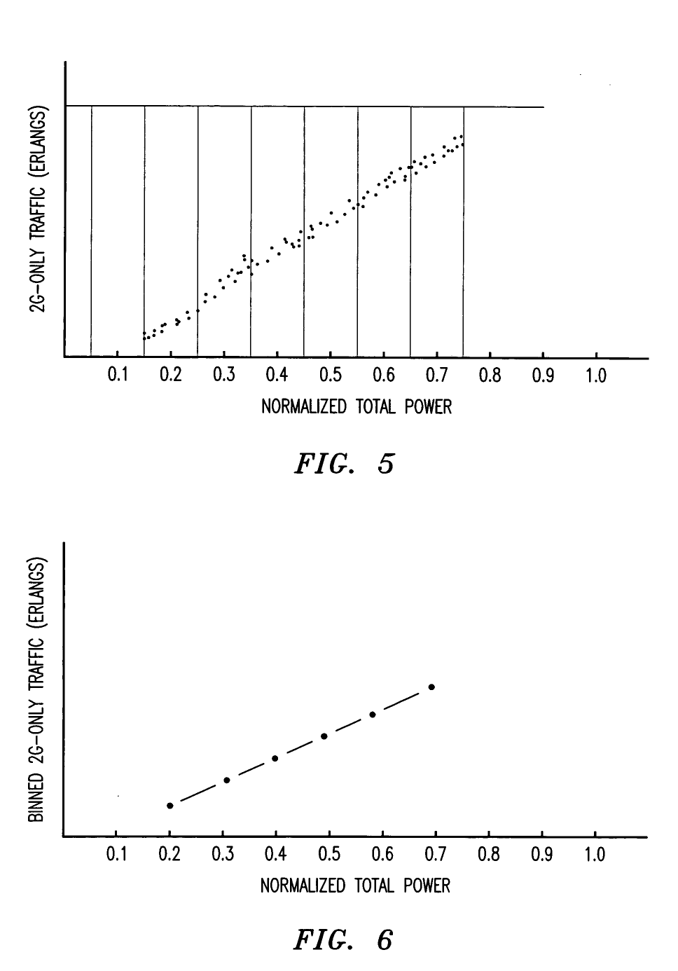

In order to determine the power used per unit of traffic for each type of traffic in a sector various methodologies can be employed. These different methodologies use service measurement data obtained from different carriers, or from the same carrier over different time intervals. For example, if a carrier consists of only 2G voice or 3G voice traffic only, then data points of normalized power versus 2G (or 3G) Erlangs can be plotted, as shown in FIG. 5. Using a convenient binning interval of, for example, 0.10, where each bin is centered at 0.10, 0.20, 0.30, etc., the data in FIG. 5 can be re-plotted as the data points 601 in FIG. 6. For each bin, then the average 2G-(or 3G) Power Fraction per Erlang, 2G_PFPE (or 3G_PFPE) can be determined from
2G_{—}PFPE={NTP−NOP}/2G_{—}PTE (1)
or:
3G_{—}PFPE={NTP−NOP}/3G_{—}PTE (2)
where NTP is the normalized total power in the specific bin, NOP is the normalized overhead power, which is the fixed portion of the total normalized power that is given to the overhead channel for the pilot signal, paging and sync, and 2G_PTE (or 3G_PTE) is the number of total 2G (or 3G) primary traffic Erlangs for that bin. 2G_PFPE (or 3G_PFPE) at the overload threshold level of 0.90 can then be determined by extrapolating the resultant 2G_PFPE (or 3G_PFPE) determined for each bin to the 0.90 normalized total power level.

If a carrier contains mixed 2G and 3G traffic, then, if there is another carrier on that sector that contains 2G-only traffic, 2G_PFPE is calculated on the carrier, as noted above. From the mixed carrier, 3G_PFPE is then calculated as:
3G_{—}PFPE={NTP−NOP−(2G_{—}PTE×2G_{—}PFPE)}/3G_{—}PTE (3)
where NTP and NOP are as described above, 2G_PTE is the number of 2G Erlangs in the mixed carrier, and 3G_PTE is the number of 3G Erlangs in the mixed carrier.

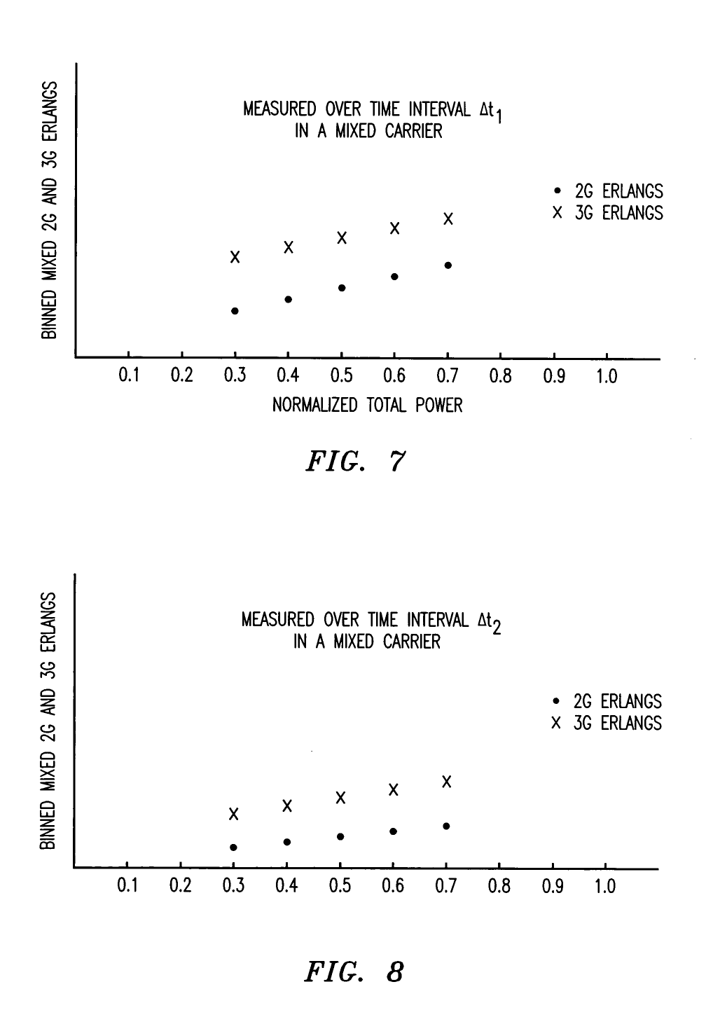

Alternatively, 2G_PFPE and 3G_PFPE can be estimated from a mixed carrier using data obtained over different time intervals. For example, from service measurement made over different time intervals Δt₁ and Δt₂, the normalized total power versus binned mixed 2G- and 3G-Erlangs may look like the data represented in FIGS. 7 and 8, respectively. From the data measured over the first interval, Δt₁, the following relationship exists for each bin:
a_{Δt1,2G}(2G_{—}PFPE)+a_{Δt1,3G}(3G_{—}PFPE)=NTOP_{Δt1} (4)
where NTOP_{Δt1}, is the normalized power in the specific bin as measured over time interval Δt₁, and a_{Δt1,2G} and a_{Δt1.3G} are the 2G and 3G traffic, respectively, in the bin as determined from the data measured over interval Δt₁. Similarly, from the data measured over interval Δt₂ the following relationship exists:
aₜ2,2G (2G_{—}PFPE)+a_{Δt2,3G}(3G_{—}PFPE)=NTOP_{Δt2} (5)
where NTOP_{Δt}2 is the normalized power in the specific bin as measured over time interval Δt₂, and a_{Δt2,2G} and a_{Δt2,3}_{G} are the 2G and 3G traffic, respectively, in the bin as determined from the data measured over interval Δt₂. Since 2G_PFPE and 3G_PFPE are independent of the time interval in which they are measured, equations (4) and (5) can be solved since a_{Δt1,2G}, aΔt1,3G, a_{Δt2,2G}, a_{Δt2,3G}, NTOP_{Δt1}, and NTOP_{Δt2} are known from the service measurement data. Thus, 2G_PFPE and 3G_PFPE can be separately determined for each bin.

If more types of traffic are present on the mixed carrier, such as 3G-data users, then the power usage per unit of traffic of each type of traffic can be obtained by a natural and logical extension of the above approach. For such data traffic, the service measurement that can be used to characterize it is the average throughput in kbps. Thus, for data traffic, a relevant measure could be power/kbps. For three types of traffic in a mixed carrier, the usage measured over three different time interval could be estimated and used to derive the relevant power usage for each type of traffic.

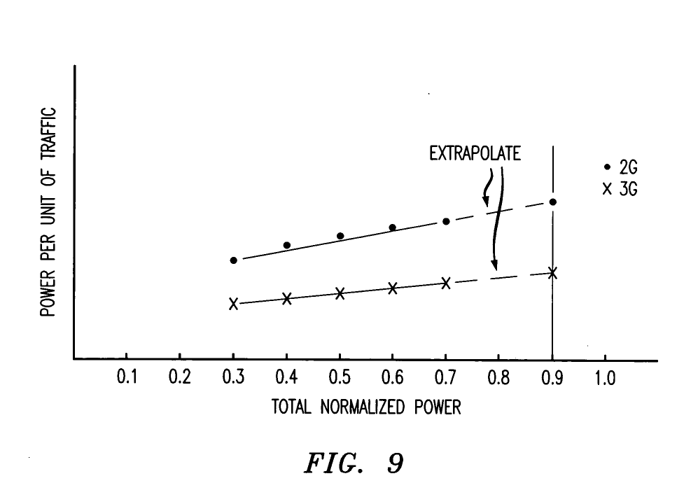

Once the power per unit of traffic is determined for each type of traffic versus total normalized power for each unit of traffic (e.g., 2G_PFPE, 3G_PFPE), then those data points can be used to extrapolate each parameter to the power per unit of traffic at the threshold at which undesirable blocking has been determined to occur. Thus, using the exemplary threshold level of 0.90 total normalized power, the determined 2G_PFPE and 3G_PFPE data points, for example, are extrapolated to the total normalized power of 0.90 as shown in FIG. 9 in order to determine 2G_PFPE_{0.90} and 3G_PFPE_{0.90}, respectively, at that threshold level. One can also perform a sensitivity analysis by using slightly different values for 2G_PFPE_{0.90} and 3G_PFPE_{0.90} obtained, for example, from adjacent bins. This will indicate the sensitivity of the projected time when capacity will be reached thereby enabling bounds to be placed on the time when a new growth carrier is needed.

Once the power per unit of traffic for each type of traffic at the threshold level is determined, the time at which that threshold level of total normalized power will be reached can be projected using the projections of traffic level for each type of traffic, such as those shown in FIG. 4. Thus, at successive times along the time line beyond the present time, the following is calculated:

$$NTP = NOP + {\sum }_{{all}_{{types}_{{of}_{traffic}}}} \begin{matrix}( units\_of \_traffic \_type ) \times \\ ( power\_per \_unit \_of \_traffic \_type )\end{matrix} \qquad ( 6 )$$

where, as above NTP is the normalized power total and NOP is the normalized overhead power. The units_of_traffic_type for each type of traffic is determined from the growth rate projections of each type of traffic and the power per_unit_of_traffic at the threshold is determined as described above, for example the 2G_PFPE_{0.90} and 3G_PFFE_{0.90}. Thus, as NTP is repeatedly calculated along the time axis, the point at which NTP equals the threshold of, for example, 0.90, will eventually be reached. That point then is the projected time at which the sector will reach its capacity and when a new carrier needs to be introduced in order to maintain blocking at what has been decided to be an acceptable level of blocking.

Although a graphical analysis has been described above for determining at least in part an estimate of when the capacity of a cell sector will be reached, it should be understood by those skilled in the art that the methodology of each described embodiment could be implemented or automated in various ways, including software and/or hardware implementations.

While the particular invention has been described with reference to illustrative embodiments, this description is not meant to be construed in a limiting sense. It is understood that although the present invention has been described, various modifications of the illustrative embodiments, as well as additional embodiments of the invention, will be apparent to one of ordinary skill in the art upon reference to this description without departing from the spirit of the invention, as recited in the claims appended hereto. Consequently, the invention may be implemented in different locations, such as at a base station, a base station controller and/or mobile switching center, or elsewhere. Moreover, processing circuitry required to implement and use the described invention may be implemented in application specific integrated circuits, software-driven processing circuitry, firmware, programmable logic devices, hardware, discrete components or arrangements of the above components as would be understood by one of ordinary skill in the art with the benefit of this disclosure. Those skilled in the art will readily recognize that these and various other modifications, arrangements and methods can be made to the present invention without strictly following the exemplary applications illustrated and described herein and without departing from the spirit and scope of the present invention. It is therefore contemplated that the appended claims will cover any such modifications or embodiments as fall within the true scope of the invention.

1. A method for use in a CDMA wireless communications system comprising the step of:
determining, using service measurements made at a cell of cell power versus traffic, and predictions of traffic growth at that cell, a time in the future at which traffic at the cell is predicted to reach a capacity that causes the power of that cell to reach a predetermined threshold level, wherein the predetermined threshold level is the level associated with a predetermined blocking criteria.

2. The method of claim 1 wherein the time in the future is the time when the power at the cell is predicted to reach approximately 80% or more of a maximum cell power.

3. The method of claim 2 wherein the time in the future is the time when the power at the cell is predicted to reach approximately 90% or more of a maximum cell power.

4. The method of claim 1 wherein the predetermined blocking criteria is approximately 2% blocking.

5. The method of claim 1 wherein the step of determining a time in the future comprises the steps of:
extrapolating from the measurements of power versus traffic, the level of traffic associated with the predetermined threshold level of power; and
determining from the traffic growth predictions when that extrapolated level of traffic is predicted to be reached.

6. The method of claim 1 wherein the traffic comprises a plurality of different types of traffic, each type of traffic having an associated prediction of traffic growth, and the step of determining a time in the future comprises the step of:
determining, using the prediction of traffic growth for each type of traffic, when in the future the sum of the powers of each of the different types of traffic is predicted to equal the predetermined threshold.

7. The method of claim 6 wherein the step of determining when the sum of the powers of each of the different types of traffic is predicted to equal the predetermined threshold comprises the steps of:
determining from the service measurements a relationship between cell power and power per unit of traffic for each type of traffic;
using the determined relationship between cell power and power per unit of traffic to predict for each type of traffic a power per unit of traffic for a power level equal to the predetermined threshold, and
using the predicted traffic growth of each type of traffic, determining when in the future the sum of the products of the determined power per unit of traffic for a power level equal to the predetermined threshold and the predicted units of traffic of each type of traffic is predicted to equal the predetermined threshold.

8. The method of claim 7 wherein the different types of traffic comprises at least two from among 2G voice traffic, 3G voice traffic and 3G data traffic.

9. The method of claim 1 wherein the determination of when the cell capacity is predicted to be reached is made on a cell sector basis.

10. A method of determining the capacity of a cell in a CDMA wireless communications system comprising the steps of:
using service measurements made in the cell of cell power versus traffic, extrapolating the measured cell power to a predetermined power level that is associated with a predetermined level of blocking; and
determining a traffic level associated with that predetermined power level.

11. The method of claim 10 wherein the predetermined power level of blocking is approximately 2%.

12. The method of claim 11 wherein the predetermined power level associated with the predetermined level of blocking is approximately 80% or more of a maximum cell power.

13. The method of claim 12 wherein the predetermined power level associated with the predetermined level of blocking is approximately 90% or more of a maximum cell power.

14. The method of claim 10 wherein the traffic level associated with the predetermined power level is determined on a cell sector basis.
